(19) United States
(12) Patent Application Publication
(10) Pub. No.: US 2008/0239450 A1
(43) Pub. Date: Oct. 2, 2008

(54) Controllable Optical Lens

(75) Inventors: Albert H.J. Immink, Eindhoven (NL); Bernardus H.W. Hendriks, Eindhoven (NL); Stein Kuiper, Vught (NL); Marco A.J. Van As, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,340

(22) PCT Filed: Mar. 29, 2005
(86) PCT No.: PCT/IB2005/051053

§ 371 Date: Sep. 26, 2006

(30) Foreign Application Priority Data
Mar. 30, 2004 (GB) 0407236.9

(51) Int. Cl. G02F 1/1343; G02B 3/14

(52) U.S. Cl. 359/254; 359/666

(57) ABSTRACT

A controllable optical lens comprises a chamber housing first and second fluids, the interface between the fluids defining a lens surface. An electrode arrangement controls the shape of the lens surface and is also for sensing the shape of the lens surface. The electrode arrangement comprising a plurality of electrode segments at different angular orientations about an optical axis of the lens. Surface characteristics are sensed at a plurality of angular orientations from the plurality of electrode segments, and in this way the local shape characteristics of the lens at different angular positions around the lens can be determined. In this way, asymmetry can be detected.

This invention relates to a controllable optical lens, in particular using the so-called electrowetting principle (also known an electrocapillarity).

An electrowetting lens comprises a chamber housing two non-miscible liquids, such as an electrically insulating oil and a water based conducting salt solution, and the meniscus between these fluids defines a refractive index boundary and therefore defines a lens function. The shape of the meniscus is electrically controllable to vary the power of the lens. The fluid may comprise a liquid, vapour, gas, plasma or mixture thereof.

The electrical control of the lens shape is achieved using an outer annular control electrode, and the electrowetting effect is used to control the contact angle of the meniscus at the outside edge of the chamber, thereby changing the meniscus shape.

The basic design and operation of an electrowetting lens will be well known to those skilled in the art. By way of example, reference is made to WO 03/069380.

Electrowetting lenses are compact and can provide a variable focusing function without any mechanical moving parts. They have been proposed in various applications, particularly where there are space limitations and where power consumption is to be kept to a minimum, for example use as an autofocus camera lens in a mobile phone.

The environmental conditions to which a lens in this application is exposed require the lens to operate well for a temperature range of around −30° C. to +60° C., and correct operation over this range of temperatures provides problematic design issues.

It is known to choose the oil based liquid and the water based liquid such that their density is equal. This makes the shape of the water-oil meniscus insensitive to the orientation of the lens (i.e. insensitive to the direction of gravity). However, this only applies for a specific temperature. When temperature changes, the oil and water will expand unequally, resulting in a difference in density between the oil and water. This makes the shape of the meniscus sensitive to the orientation of the lens. This change of the meniscus shape in turn causes optical aberrations such as coma.

Due to slow charging of the insulators (between the electrodes and the fluids) the relation between the voltage and the exact position of the oil-water meniscus is also subject to drift.

A conventional electrowetting lens has a bottom electrode and a circumferential wall electrode as mentioned above. Due to this circular symmetric structure of conventional electrowetting lenses, aberrations in the shape of the meniscus due to gravity effects cannot be compensated for. It is also not possible to measure asymmetric changes in the shape of the meniscus.

According to the invention, there is provided a controllable optical lens, comprising:
a chamber housing first and second fluids, the interface between the fluids defining a lens surface;
an electrode arrangement for electrically controlling the shape of the lens surface and for sensing the shape of the lens surface, the electrode arrangement comprising a plurality of electrode segments at different angular orientations about an optical axis of the lens; and
a sensing arrangement for determining, from at least the plurality of electrode segments, lens surface characteristics at a plurality of angular orientations.

In this arrangement, angularly spaced electrode segments are provided, and these can be used to perform a proximity sensing function to determine the local shape characteristics of the lens at different angular positions around the lens. In this way, asymmetry can be detected. With appropriate design of the control electrode arrangement, this detected asymmetry can be corrected.

The sensing arrangement preferably comprises a capacitance sensing arrangement.

The electrode arrangement preferably comprises a drive electrode arrangement comprising a base electrode and a side wall electrode. These are used to control the lens shape, and this can be carried out in known manner.

In one version of the invention, the electrode arrangement further comprises a patterned top electrode, which comprises the plurality of electrode segments. Thus, a patterned top electrode pattern is used for proximity lo sensing of the lens interface surface at multiple angular locations.

The patterned top electrode is made from a substantially transparent electrically conductive material, such as ITO, and does not therefore obscure the path of light through the lens.

The side wall electrode may comprises a single annular electrode which surrounds the chamber, as is conventional. In this case, the capacitance sensing arrangement can be used for sensing the capacitance defined between each of the plurality of electrode segments and the side electrode.

The side wall electrode may instead comprises a first driving electrode portion (the conventional part) and additionally one or more sensing electrode portions, the sensing electrode portions comprising annular electrodes surrounding the chamber and spaced along the optical axis from the driving electrode portion. In this case, the capacitance sensing arrangement can be arranged to sense the capacitance defined between a plurality of pairs of electrodes, the pairs each comprising one of the plurality of electrode segments and one of the sensing electrode portions of the side electrode. In this way, part of the side wall electrode is used for the normal driving function, and part is used for the sensing function.

Alternatively, the capacitance sensing arrangement can be arranged for sensing the capacitance defined between pairs of the electrode segments, and use of the side wall electrode in the sensing operation is thus not essential.

In an alternative arrangement, the drive electrode arrangement may comprise a plurality of side wall electrodes disposed angularly spaced around the chamber, and wherein the plurality of side wall electrodes comprise the plurality of electrode segments. In this case, the side wall electrode is split up into segments to enable local lens shape sensing at different angular positions. In addition, however, the segmented side wall electrode enables a drive scheme to be implemented which can correct for asymmetry. In particular, different control voltages can be applied to the side wall electrode segments to drive the lens in an asymmetric manner, for example to correct for asymmetry resulting from thermal and gravitational effects.

In this arrangement, the a resistance or capacitance sensing arrangement can be used, for sensing the resistance or capacitance between each of the plurality of electrode segments and the base electrode, and no top electrode is thus required. The local proximity sensing is thus performed at the chamber outer wall.

However, a top electrode can also be employed with the segmented side wall implementation. In this case, the top electrode may comprise a single central electrode, and a capacitance sensing arrangement can then be for sensing the capacitance defined between each of the plurality of side wall electrode segments and the top electrode.

The capacitance sensing arrangement may comprise an alternating current source for applying a first signal to a first electrode of a selected pair of electrodes, and a combiner for combining a second signal received from a second electrode of a selected pair of electrodes with the first signal, and a filter. This provides a coherent detector capacitance measurement technique, although any other known capacitance measuring technique may be employed.

In the lens, the first fluid preferably comprises a water based liquid and the second fluid preferably comprises an oil based liquid.

Examples of the invention will now be described in detail with reference to the accompanying drawings, in which:

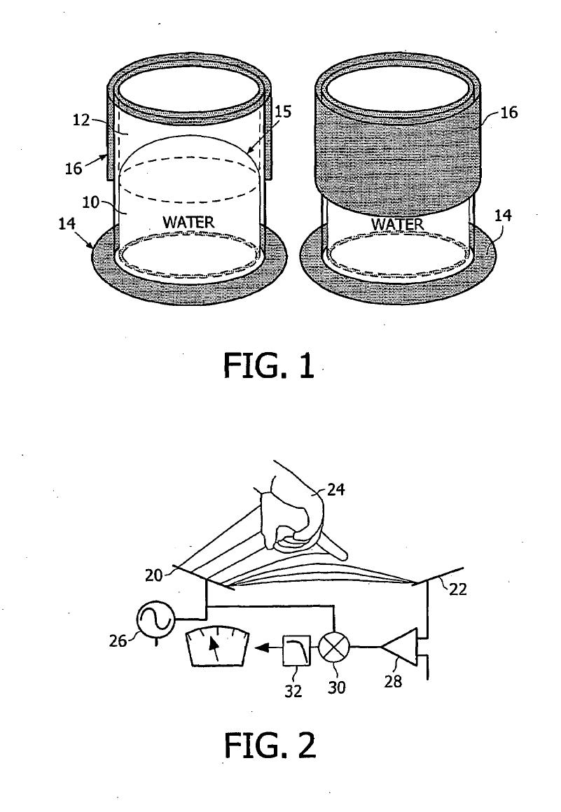

FIG. 1 shows a known design of electrowetting lens;

FIG. 2 is used to explain the principle of cross capacitance sensing;

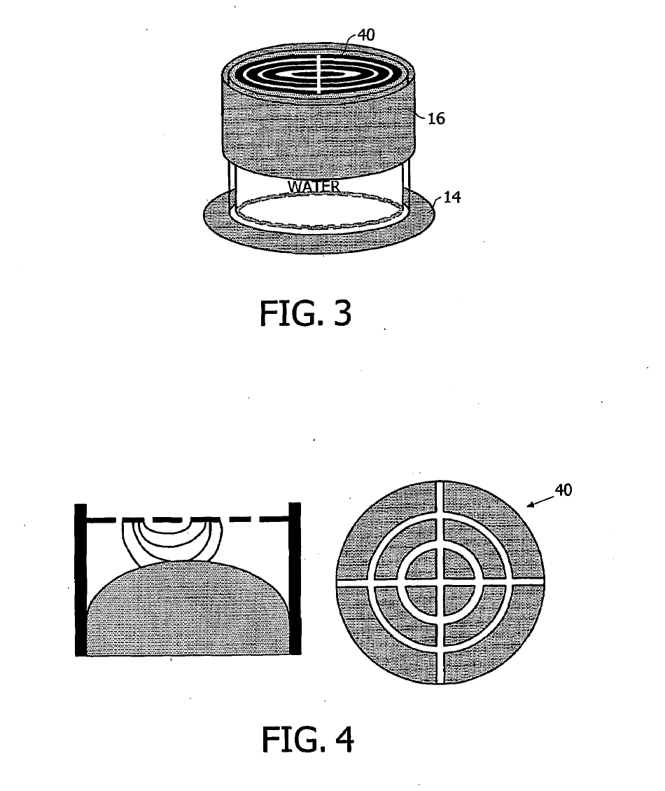

FIG. 3 shows a first example of lens of the invention;

FIG. 4 shows the top electrode used in the lens of FIG. 3;

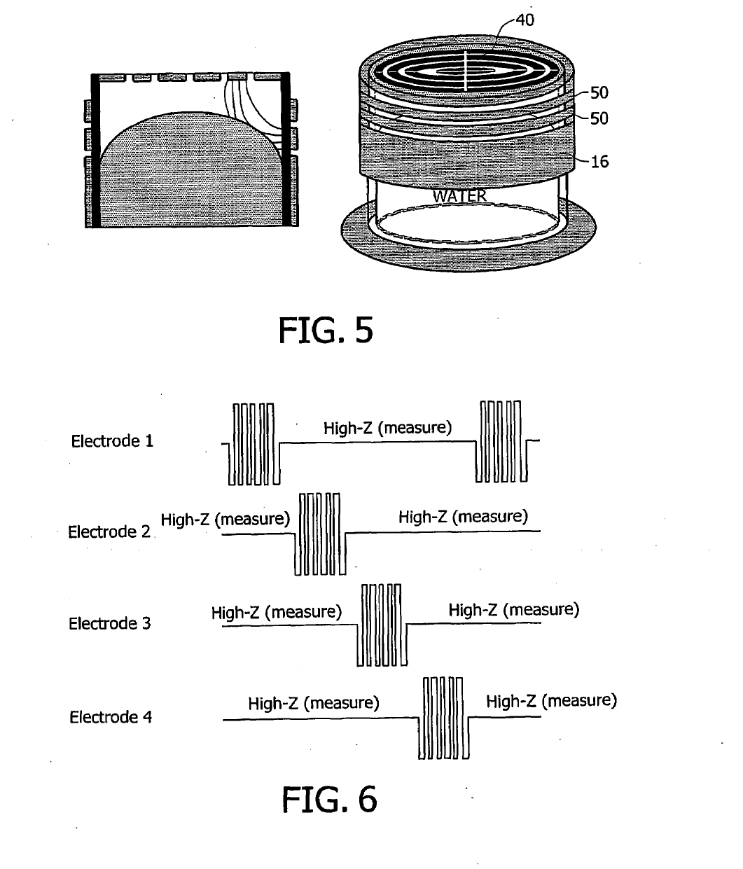

FIG. 5 shows a second example of lens of the invention;

FIG. 6 is used to explain a sensing method for use with the lens of the invention;

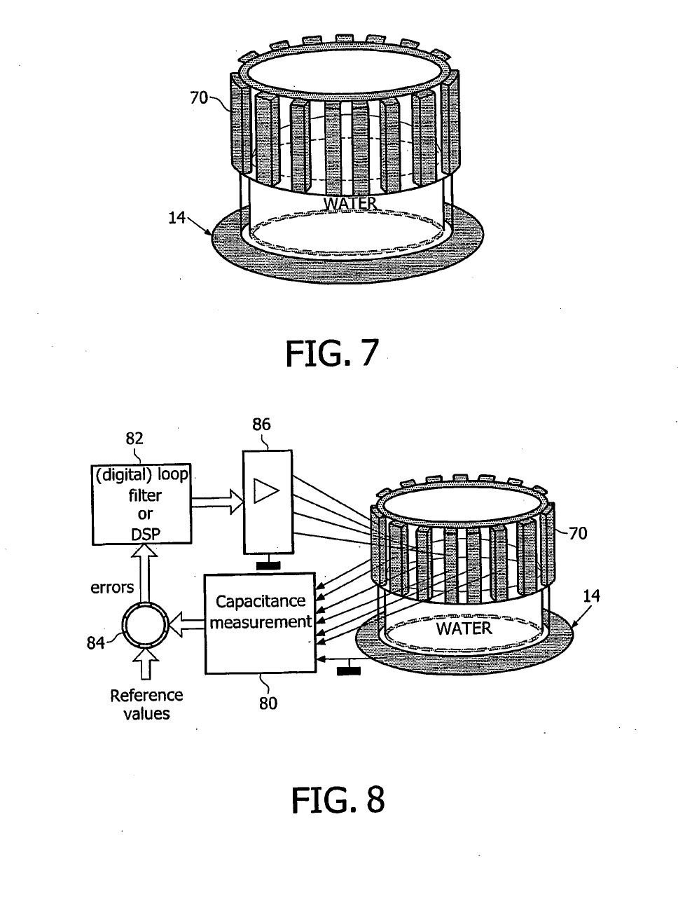

FIG. 7 shows a third example of lens of the invention; and

FIG. 8 shows drive and sense circuitry for use with the lens of FIG. 7.

FIG. 1 schematically shows a known electrowetting lens design. The left part of FIG. 1 shows the interior of the lens. The lens comprises a chamber which houses a polar and/or conducting liquid such as a salted water based component 10 (which is referred to simply as water below) and a nonconducting liquid such as an oil based component 12 (which is referred to simply as oil below). A bottom electrode 14 and a circumferential side electrode 16 control the power of the lens. The side electrode is separated from the liquid by an insulator which forms the side wall of the chamber, and this insulator acts as a capacitor dielectric layer during electrical operation: of the lens. This operation will be well known to those skilled in the art, and reference is made to WO 031069380. As shown in the right part of FIG. 1, the side electrode 16 covers the complete circumference of the lens.

The two electrodes are used to drive the lens with a voltage to change the shape and thus the strength of the lens according to:

$$S = {S}_{0} + \frac{( {n}_{1} - {n}_{2} ) ɛ}{2 Rd γ} {V}^{2}$$

Where S₀ is the strength of the lens when the applied voltage is zero, n1 and n2 are the refractive indices of water and oil respectively, ε is the dielectric constant of the insulator (i.e. the wall of the chamber), γ is the oil-water surface tension, R is the cylinder radius, d is the insulator thickness and V is the applied voltage between the electrodes.

It has been proposed that the capacitance across the electrodes can be measured to provide feedback about the shape of the lens. In particular, the shape and the position of the meniscus changes when a voltage is applied, so that the effective size of the annular electrode changes (the effective size depends on the area of water in contact with the electrode, which changes as the meniscus position changes). A resulting change in capacitance can be measured, and this capacitance has been considered to be a reasonably accurate parameter for measuring the strength of the lens. This capacitance measurement does not, however, provide any feedback concerning asymmetry in the lens shape.

The invention provides an electrode arrangement for electrically controlling the shape of the lens surface and for sensing the shape of the lens surface. There are many different variations for the parts of the electrode arrangement for performing the driving function and the parts of the electrode arrangement for performing the sensing function, and indeed some of the electrodes may perform both functions. In all embodiments, the electrode arrangement comprises a plurality of electrode segments at different angular orientations about an optical axis of the lens. A capacitance sensing arrangement is provided for determining, from at least the plurality of electrode segments, the local lens surface positions or angle at a plurality of angular orientations. This enables asymmetry to be detected, and this can be used in a feedback control system to provide correction for asymmetry.

A first implementation of the invention uses a cross-capacitance sensing technique. This principle of this technique will first be explained with reference to FIG. 2, before the invention is described in detail. It is known that capacitive sensors can be used as proximity sensors to detect the position of (conducting) objects in a 3D space. The principle of cross-capacitance sensing is that if a conducting object is placed near two electrodes, some of the electromagnetic field lines between them will be terminated on the object, and this interruption of the electric field decreases the cross-capacitance (i.e. the capacitance between the two electrodes).

This can be accurately measured with so-called “lock-in techniques” for measuring capacitance.

FIG. 2 shows first and second electrodes 20,22 with a hand 24 interrupting the electromagnetic field lines between the electrodes. One electrode 20 of the capacitor is driven with an oscillating signal 26. The signal on the other electrode 22 is detected, amplified by amplifier 28 and multiplied in combiner 30 with the original oscillating signal of the first electrode. This provides a synchronous detection system. A simple low-pass filter 32 is then used to filter out the noise at all frequencies of no interest. The cut-off of this low-pass filter 32 determines the response time and thus the speed of measurement.

In the first implementation of the invention, a cross capacitance measurement technique such as that described above is used as a proximity sensing method for detecting the spatial position of the meniscus. This enables the exact position and 3D-shape of the electrowetting lens to be detected. This proximity sensing is possible because the oil is an insulator and the lens fluid (water) is a relatively good conductor. The interface thus acts as an electromagnetic shield.

FIG. 3 shows a first example of electrode arrangement for use in a lens of the invention.

In addition to the conventional bottom and side control electrodes 14, 16, the lens has a patterned top electrode 40. The patterned top electrode comprises a number of discrete electrodes, and this enables different pairs of electrodes to be selected for cross capacitance measurement, in order to detect the local proximity of the meniscus.

The preferred position of this proximity sensing electrode pattern is at the top of the meniscus. This electrode pattern is in the optical path, and a transparent conducting material, such as ITO, is therefore used. The electrode configuration can be patterned in many different ways and with a varying number of segments depending on the exact aberration that is to be measured with the highest accuracy.

FIG. 4 gives one example of electrode pattern 40. The pattern comprises an array of concentric sections, to provide radial information. Each concentric section is divided into segments, to provide angular resolution of the proximity information, in particular so that asymmetry can be detected. In the example shown, there are three concentric rings, each ring being divided into four segments. The pattern of FIG. 4 is thus essentially in the form of a dartboard.

The contact leads are not shown in FIG. 4. In a practical layout, ITO leads with small width could be employed, between the different electrode segments. FIG. 4 also shows the electric field shielding provided at the meniscus, and which causes the electrode cross capacitance to change.

Many different electrode configurations can be employed. A patterned side wall electrode can also be employed. FIG. 5 shows a modification in which wall electrode 16 is patterned with additional rings 50 above the main control part of the electrode, and in the vicinity of the meniscus. FIG. 5 also shows how the meniscus position alters the electromagnetic field lines between the patterned top electrodes and the rings 50 of the side electrode 16. The patterned ITO layer forming the top electrode is not in focus, so it does not deteriorate the imaging quality of the lens. The ITO layer will provide some scattering, but this will only influence the contrast of the image, and this effect has been found to be negligible.

There are various ways of controlling the electrodes to provide the desired proximity sensing information. Various different drive schemes will be apparent to those skilled in the art, and one possible drive scheme implementation is described below with reference to FIG. 6.

In the drive scheme of FIG. 6, one of the electrodes is driven at a time with a constant frequency fd, and the signals from all other electrodes are simultaneously measured using the lock-in process explained above. Each electrode is driven in sequence with the same constant frequency fd and the previously driven electrode is used as one of the receiving electrodes. In this driving scheme, each electrode is used as a ‘sender’ once during a complete cycle of the drive scheme.

An alternative drive scheme takes advantage of the low-pass filter used in the lock-in detection process explained above. Lock-in detection is used with a low-pass filter that is as narrow as possible at the required response time (for best noise performance). It is therefore possible to drive the electrodes simultaneously with different frequencies f1; f2; : : : ; fn with a difference that is larger than the cut-off frequency of the low-pass filter.

The amplitude of the driving signal on the ITO-electrodes must be sufficiently small that it does not influence the shape of the lens. The shape of the lens should thus only be determined by the voltage on the wall electrodes.

The examples described above use a cross capacitance measurement, so that the capacitance between two electrodes is influenced by the presence of a conducting body in the electric field between the two electrodes. It is equally possible to carry out a direct capacitance measurement between the electrode segments of the patterned top electrode and the conducting fluid of the lens.

In this case, the capacitance is measured between the top electrode segment and the side wall electrode or even the bottom electrode.

In the same way, the direct capacitance between the additional side wall electrodes shown in FIG. 5 and the lens fluid can be measured.

In both cases, the sender-receiver principle with lock-in detection can be applied. Of course, other capacitance measurement principles are possible. The examples above each use a patterned top electrode to provide localized proximity sensing. It is also possible to use partitioning of the wall electrode to provide localized shape information without the need for a patterned top electrode.

FIG. 7 shows an arrangement in which the wall electrode 16 is split into a number of axial electrodes 70. A capacitance measurement can then be carried out for each individual axial electrode.

In this way, for each of the electrodes 70, a capacitance with respect to the bottom electrode 14 can be measured independently. This then provides not only information about the global strength of the lens, but also the asymmetric shape of the meniscus.

The segmented side wall electrode also allows each electrode 70 to be driven independently with a driving voltage that is a function of the measured capacitances and the required shape and strength of the lens. When different voltages are applied across the circumference, the angle the liquid will make with the cylinder wall will vary across the circumference leading to a deformation of the meniscus. This can be used to compensate for lens aberrations due to gravity.

The driving voltages can be calculated continuously such that the aberration is minimized at each orientation of the lens with respect to the field of gravity. A block diagram of a system for implementing this control scheme is shown in FIG. 8.

Each electrode 70 connects to a capacitance measurement circuit 80, to perform the sensing operation. When driving the electrodes 70, the angle of the conducting liquid (water) with the wall of the lens cylinder will vary as function of the voltage. Control of the voltages can be achieved using a loop-filter 82 which receives error values from a comparator 84. The comparator 84 compares the measured capacitance values with reference values for the desired optical power. The loop filter can implement a linear control scheme, for example PI (proportional-integral) control using an Integrating loop filter. The changes may be relatively slow, so it may also be possible to calculate the voltages with a DSP (digital signal processor) based on the output of the comparison between the measured capacitances and the reference values. In that case it is more easy to apply more sophisticated non-linear control scheme.

Voltage drivers 86 controlled by the filter or DSP provide the drive voltages to the electrodes 70.

In the example of FIG. 7, a resistance measurement between each segmented electrode 70 and the base electrode 14 can be used instead of a capacitance measurement. In particular, when the lens power changes, a different the height of the conducting liquid up the chamber side wall results. This changes the electrical path between the electrode 70 and the base electrode 14 in two ways. Firstly, the length of the conductive path through the conducting liquid is changed. Secondly, the effective area of material of the electrode 70 in the electrical path changes. These changes make the series resistance dependent on the lens shape. Thus, in some examples of the invention, resistive measurements can be used instead of capacitive measurements.

In the examples above using capacitance measurement, only one implementation of capacitance measurement has been described in detail. There are of course numerous other possible implementations.

In one example above, an electrode arrangement has a plurality of electrode segments at different linear positions along the optical axis of the lens, so that lens surface characteristics at a plurality of linear positions along the optical axis can be determined. This approach can be used independently of the other multiple segment configurations to provide a way of obtaining sensing measurements which can easily distinguish between different lens positions. As the meniscus position changes, there is a large change in the resistance or capacitance signal for the individual segments.

Various other modifications will be apparent to those skilled in the art.

1. A controllable optical lens, comprising:
a chamber housing first and second fluids (10,12), the interface between the fluids defining a lens surface (15);
an electrode arrangement (14,16,40,50,70) for electrically controlling the shape of the lens surface and for sensing the shape of the lens surface, the electrode arrangement comprising a plurality of electrode segments (40,70) at different angular orientations about an optical axis of the lens; and
a sensing arrangement (80) for determining, from at least the plurality of electrode segments (40,70), lens surface characteristics at a plurality of angular orientations.

2. A lens as claimed in claim 1, wherein the sensing arrangement (80) comprises a capacitance sensing arrangement.

3. A lens as claimed in claim 1 or 2, wherein the electrode arrangement comprises:
a drive electrode arrangement comprising a base electrode (14) and a side wall electrode (16).

4. A lens as claimed in claim 3, wherein the electrode arrangement further comprises a patterned top electrode (40), which comprises the plurality of electrode segments.

5. A lens as claimed in claim 4, wherein the patterned top electrode (40) is made from a substantially transparent electrically conductive material.

6. A lens as claimed in claim 5, wherein the pattered top electrode is made from ITO.

7. A lens as claimed in claim 4, 5 or 6, wherein the side wall electrode (16) comprises an annular electrode which surrounds the chamber.

8. A lens as claimed in claim 7, wherein the side wall electrode (16) comprises a first driving electrode portion and one or more sensing electrode portions (50), the sensing electrode portions comprising annular electrodes surrounding the chamber and spaced along the optical axis from the driving electrode portion.

9. A lens as claimed in any one of claims 4 to 8, wherein the sensing arrangement comprises a capacitance sensing arrangement for sensing the capacitance defined between pairs of the electrode segments.

10. A lens as claimed in any one of claims 4 to 8, wherein the sensing arrangement comprises a capacitance sensing arrangement for sensing the capacitance defined between each of the plurality of electrode segments and the side electrode.

11. A lens as claimed in claim 8, wherein the sensing arrangement comprises a capacitance sensing arrangement for sensing the capacitance defined between a plurality of pairs of electrodes, the pairs each comprising one of the plurality of electrode segments (40) and one of the sensing electrode portions (50) of the side electrode.

12. A lens as claimed in claim 3, wherein the drive electrode arrangement comprises a plurality of side wall electrodes (70) disposed angularly spaced around the chamber, and wherein the plurality of side wall electrodes comprise the plurality of electrode segments.

13. A lens as claimed in claim 12, wherein the sensing arrangement (80) comprises a resistance sensing arrangement for sensing the resistance between each of the plurality of electrode segments (70) and the base electrode (14).

14. A lens as claimed in claim 12, wherein the sensing arrangement (80) comprises a capacitance sensing arrangement for sensing the capacitance defined between each of the plurality of electrode segments (70) and the base electrode (14).

15. A lens as claimed in claim 12, further comprising a top electrode.

16. A lens as claimed in claim 15, wherein the top electrode comprises a single central electrode.

17. A lens as claimed in claim 16, wherein the sensing arrangement comprises a capacitance sensing arrangement for sensing the capacitance defined between each of the plurality of electrode segments (70) and the top electrode.

18. A lens as claimed in claim 15, wherein the top electrode comprises a comprises a patterned top electrode, which comprises a plurality of top electrode portions.

19. A lens as claimed in any one of claims 15 to 18, wherein the top electrode is made from a substantially transparent electrically conductive material.

20. A lens as claimed in claim 19, wherein the top electrode is made from ITO.

21. A lens as claimed in any one of claims 1 to 12 or 14 to 30, wherein the sensing arrangement (80) comprises a capacitance sensing arrangement comprises an alternating current source (26) for applying a first signal to a first electrode of a selected pair of electrodes, and a combiner (30) for combining a second signal received from a second electrode of a selected pair of electrodes with the first signal, and a filter (32).

22. A lens as claimed in any preceding claim, wherein the first fluid (10) comprises a polar and/or conductive liquid and the second fluid (12) comprises a nonconductive liquid.

23. A lens system comprising:
a lens and sensing arrangement as claimed in any one of claims 12 to 20; and
a drive arrangement for providing independently controllable drive voltages to the plurality of side wall electrodes based on the sensing arrangement outputs.

24. A lens system comprising:
a lens and sensing arrangement as claimed in any one of claims 1 to 22; and
a drive arrangement for providing a drive voltage to the electrode arrangement based on the sensing arrangement outputs.

25. A controllable optical lens, comprising:
a chamber housing first and second fluids, the interface between the fluids defining a lens surface;
an electrode arrangement for electrically controlling the shape of the lens surface and for sensing the shape of the lens surface, the electrode arrangement comprising a plurality of electrode segments at different linear positions along the optical axis of the lens; and
a sensing arrangement for determining, from at least the plurality of electrode segments, lens surface characteristics at a plurality of linear positions along the optical axis.
